(19) United States
(12) Patent Application Publication
(10) Pub. No.: US 2017/0073936 A1
(43) Pub. Date: Mar. 16, 2017

(54) SYSTEM AND METHOD FOR DETERMINING A USEFUL LIFE OF A CONSUMABLE COMPONENT

(71) Applicant: Caterpillar Inc., Peoria, IL (US)

(72) Inventors: Lonny E. Johnson, Peoria, IL (US); Brad K. Borland, Peoria, IL (US); Gopi K. Gaddipati, Peoria, IL (US)

(73) Assignee: Caterpillar Inc., Peoria, IL (US)

(21) Appl. No.: 14/850,309

(22) Filed: Sep. 10, 2015

(51) Int. Cl. E02F 9/26; G08B 21/18

(52) U.S. Cl. CPC E02F 9/267; G08B 21/18

(57) ABSTRACT

A method for determining a useful life of a consumable component of a machine is provided. The method includes monitoring for a signal indicative of an identifier code associated with the consumable component and further determining the identifier code from the signal. The method further includes matching the identifier code with a set of pre-stored identifier codes. The method includes generating a first value, indicative of the useful life of the consumable component, if the identifier code matches with one of the pre-stored identifier codes from the set of pre-stored identifier codes, and generating a second value, indicative of the useful life of the consumable component, if the identifier code does not match with any of the pre-stored identifier codes from the set of pre-stored identifier codes, where the second value is lesser than the first value.

### TECHNICAL FIELD

The present disclosure relates generally to a system and a method for checking a consumable component installed in a machine, and more particularly relates to a system and a method for determining a useful life of a consumable component installed in a machine.

### BACKGROUND

Machines such as track-type tractors, dozers, motor graders and wheel loaders may use many consumable components that generally have a limited useful life, after which such components are consumed and may not be fit to be used in the machine anymore. Such consumable components may include, for example, filters and catalysts that are used to treat or condition passing fluid and often have fluid-treating coatings and/or substrates that degrade and/or are consumed over a time period, and therefore need to be periodically replaced. Typically such consumable components have a prescribed useful life associated therewith. After using a consumable component for the prescribed useful life, it is suggested that the respective consumable component be replaced with a new one. Using a consumable component beyond the prescribed useful life may damage an engine of the machine and other related accessories. Therefore it may be crucial to have accurate information about the useful life of consumable components installed in the machine, in advance. With this information, an operator and/or a control module in the machine may be able to predict beforehand when a consumable component installed in the machine needs to be replaced.

Most manufacturers of consumable components provide information about the prescribed useful life of consumable components on labels attached thereto. It may be very cumbersome to keep track of the prescribed useful life of each consumable component, for example at a worksite that involves maintaining a large fleet of different types of machines. Further sometimes the operator may tend to use a consumable component that has been manufactured by a third-party manufacturer which may not be designed with the same standards as set by Original Equipment Manufacturers (OEMs). Also occasionally the operator may use a consumable component that has been deceptively marked with OEM labels but may actually be a counterfeit product. Generally, third-party or counterfeit products cannot be expected to match the useful life of a consumable component manufactured by OEMs (hereinafter referred to as “original consumable component”). However, the operator may not always be aware of this fact and continue to use such a product for a period corresponding to prescribed useful life of a consumable component manufactured by OEMs. Since these third-party or counterfeit products may not be designed to last for a prolonged period equivalent to the prescribed useful life, their continuous use may damage the engine and other related accessories.

U.S. Granted Patent Number 8650097 describes a system and method to provide a data communication between unique ID (UID) registration center and electronic (or other) products, and the product's data management. The reference describes that the UID is previously assigned and integrated or embedded to the product, where the UID of each product is registered with one or more particular UID registration centers over at least one communication network. Each UID is operable to securely store and selectively provide access to predefined location in the product and corresponds to data file at the UID registration center, with data file being inclusive of information related to the product purchase history, current ownership, etc., and where one or more authorized parties may subsequently advantageously utilize at least one UID to access, verify, edit, transfer, transmit, and/or otherwise manage at least one information item, including ownership right related to one or more corresponding registered products in the UID registration center.

The above reference provides a system and method that may be used to identify a product. However, the reference does not provide any particular means to determine a useful life of a consumable component installed in a machine. Therefore, there is a need of a system and a method to overcome the limitation of the prior-art for determining a useful life of a consumable component installed in a machine.

### SUMMARY OF THE DISCLOSURE

In one embodiment of the present disclosure, a method for determining a useful life of a consumable component of a machine is provided. The method includes monitoring for a signal indicative of an identifier code associated with the consumable component. The method also includes determining the identifier code from the signal, in response to receiving the signal. The method further includes matching the identifier code with a set of pre-stored identifier codes. The method includes generating a first value, indicative of the useful life of the consumable component, if the identifier code matches with one of the pre-stored identifier codes from the set of pre-stored identifier codes. The method includes generating a second value, indicative of the useful life of the consumable component, if the identifier code does not match with any of the pre-stored identifier codes from the set of pre-stored identifier codes, where the second value is lesser than the first value.

In another embodiment of the present disclosure, a control system for determining the useful life of the consumable component of the machine is provided. The control system includes a transceiver configured to monitor for the signal indicative of the identifier code associated with the consumable component. The transceiver is further configured to determine the identifier code from the signal, in response to receiving the signal. The control system also includes a database having the set of pre-stored identifier codes. The control system further includes a controller in communication with the transceiver and the database. The controller is configured to match the identifier code with the set of pre-stored identifier codes. The controller is also configured to generate the first value, indicative of the useful life of the consumable component, if the identifier code matches with one of the pre-stored identifier codes from the set of pre-stored identifier codes. The controller is further configured to generate the second value, indicative of the useful life of the consumable component, if the identifier code does not match with any of the pre-stored identifier codes from the set of pre-stored identifier codes, where the second value is lesser than the first value.

In yet another embodiment of the present disclosure, the machine having a consumable component installed therein is provided. The machine includes the transceiver configured to monitor for the signal indicative of the identifier code associated with the consumable component. The transceiver is further configured to determine the identifier code from the signal, in response to receiving the signal. The machine also includes the controller in communication with the transceiver. The controller is configured to match the identifier code with the set of pre-stored identifier codes. The controller is also configured to generate the first value, indicative of the useful life of the consumable component, if the identifier code matches with one of the pre-stored identifier codes from the set of pre-stored identifier codes. The controller is further configured to generate the second value, indicative of the useful life of the consumable component, if the identifier code does not match with any of the pre-stored identifier codes from the set of pre-stored identifier codes, where the second value is lesser than the first value.

Other features and aspects of this disclosure will be apparent from the following description and the accompanying drawings.

### BRIEF DESCRIPTION OF THE DRAWINGS

FIG. 1 is a perspective view of an exemplary machine in which a consumable component is installed, in accordance with an embodiment of the present disclosure;

FIG. 2 is a partially exploded perspective view of an exemplary consumable component, in accordance with an embodiment of the present disclosure;

FIG. 3 is a schematic block diagram of an electronic device, in accordance with an embodiment of the present disclosure;

FIG. 4 is a schematic block diagram of a control system, in accordance with an embodiment of the present disclosure;

FIG. 5 is a flowchart of a method for determining a useful life of the consumable component, in accordance with one embodiment of the present disclosure; and

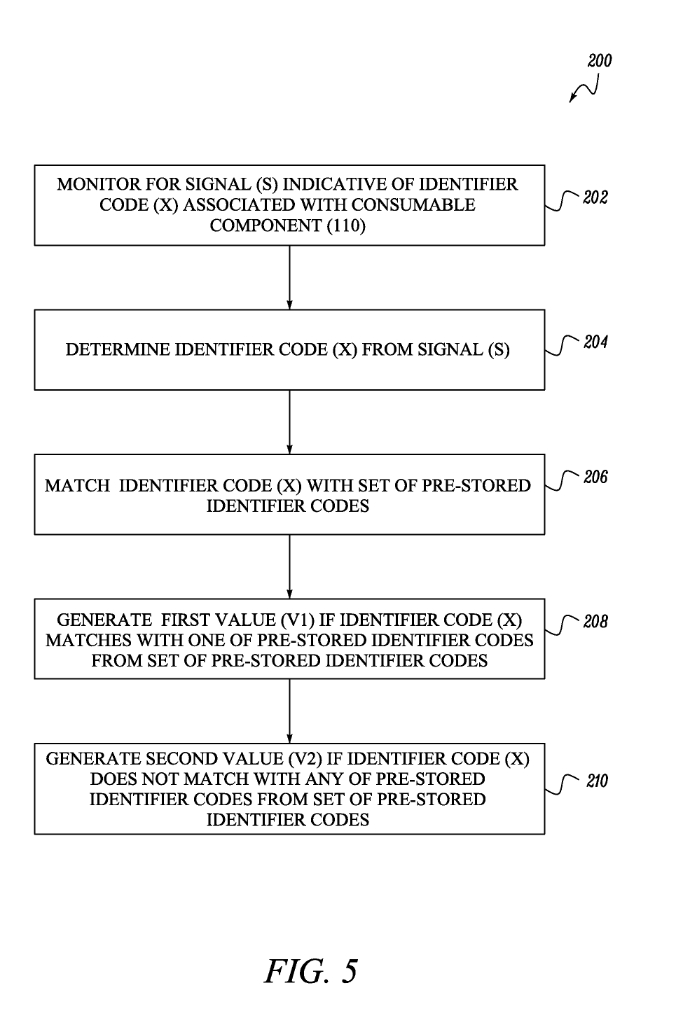

FIG. 6 is a flowchart of a method for determining a useful life of the consumable component, in accordance with another embodiment of the present disclosure.

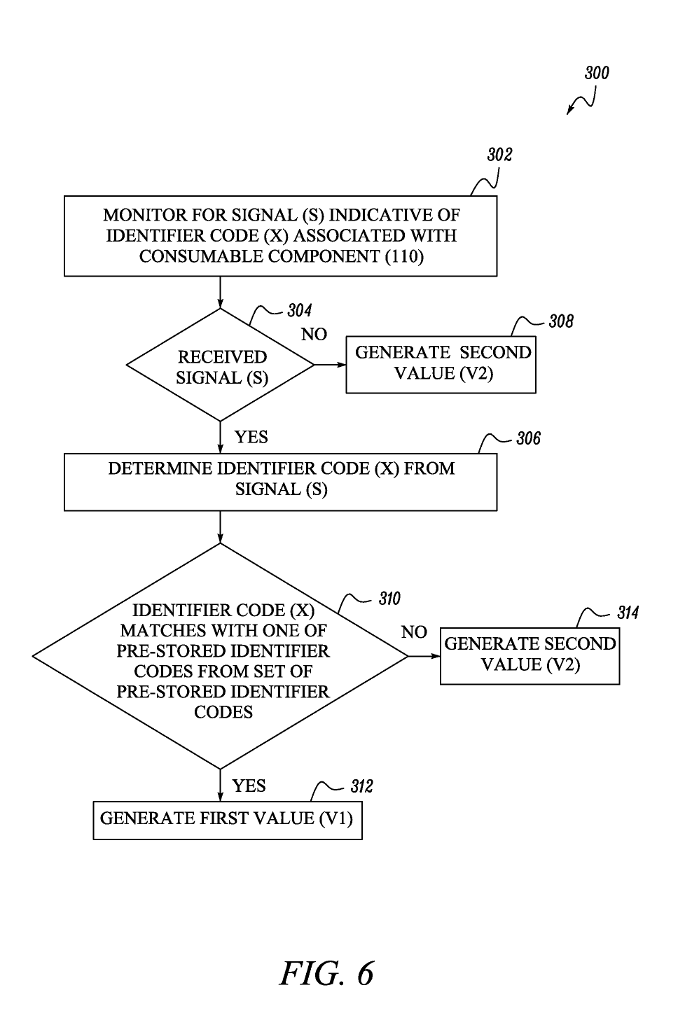

### DETAILED DESCRIPTION

Reference will now be made in detail to specific aspects or features, examples of which are illustrated in the accompanying drawings. Wherever possible, corresponding or similar reference numbers will be used throughout the drawings to refer to the same or corresponding parts.

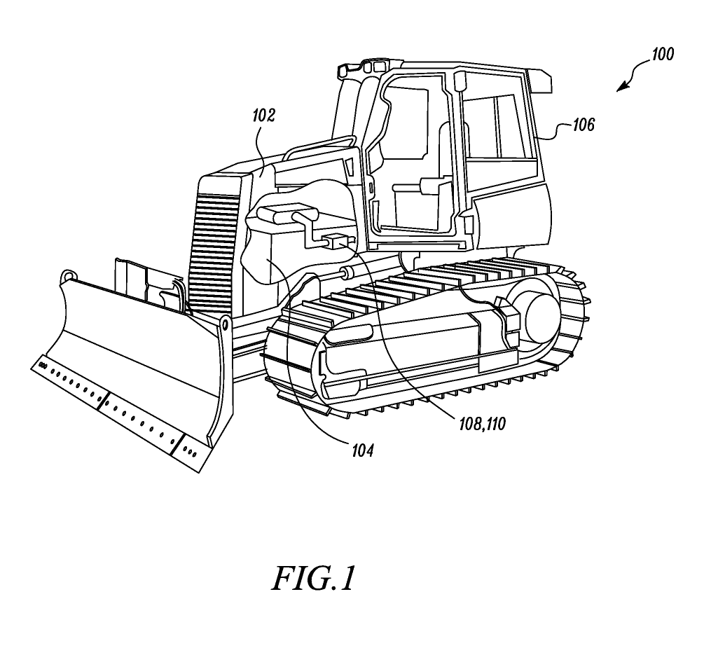

FIG. 1 illustrates a perspective view of a machine 100. The machine 100, as depicted in FIG. 1, may embody an earth moving machine, such as a dozer having traction devices, such as tracks, wheels, or the like. Alternatively, the machine 100 may be some other off-highway vehicle, such as an excavator, a backhoe, a loader, a motor grader, or any other machine. In one example, the machine 100 may be configured to perform operations in a worksite, for example, a mine site, a landfill, a quarry, a road site, a farm, a construction site, or any other similar type of worksite. The machine 100 may be any of a manual, an automated or a semi-automated machine. Alternatively and/or additionally, the machine 100 may include a stationary machine such as a generator set, a pumping device, a turbine, or some other type of stationary machine.

In the illustrated aspect of FIG. 1, the machine 100 includes a frame 102 to support the various components therein. The machine 100 may include an engine 104 configured to power the traction devices, and other systems and assemblies in the machine 100. The engine 104 may be an internal combustion engine, such as a gasoline engine, a diesel engine, a gaseous fuel burning engine, or the like. The engine 104 may be electronically controlled by an Electronic Control Module (ECM) (not illustrated). The ECM may utilize a plurality of sensors (not illustrated) for determining the operating parameters of the engine 104. Electronic Control Modules of this type are well known in the art and therefore are not further discussed for the brevity of the disclosure. The machine 100, as illustrated, may include an operator cabin 106 from where an operator of the machine 100 may control various systems and assemblies to perform the requisite operations.

As shown in the exemplary embodiment of FIG. 1, the machine 100 may include exhaust treatment devices 108. The exhaust treatment devices 108 may be configured to remove particulate matter, such as, soot and ash from an exhaust flow of the engine 104. The exhaust treatment devices 108 may include, for example, a filter configured to trap the particulate matter. It may be contemplated by a person skilled in the art that the usage of filter for extended periods of time may lead to accumulation of the particulate matter, thereby causing the filter to reduce in effective volume and resulting in a decline in engine performance. The exhaust treatment devices 108 may include other such devices, such as catalytic conversion devices that are used to treat or condition passing fluids and often have fluid-treating coatings and/or substrates that degrade and/or are consumed over a time period. In addition to the exhaust treatment devices 108, the machine 100 may include other devices that may degrade over a period of time and needs to be replaced after a prescribed time period for efficient working of the machine 100. These categories of devices are hereinafter collectively referred to as “consumable components” for the purpose of the present disclosure.

The machine 100 may include one or more consumable components 110 disposed therein. In one example, the consumable components 110 may include a variety of filters that are used to treat various kinds of fluids in the machine 100, for example, but not limited to, engine oil filters, transmission oil filters, exhaust gas filters, coolant filters, fuel filters, etc. In other example, the consumable components 110 may also include other type of components, such as, engine oil pumps, transmission oil pumps, fuel pumps, coolant pumps, etc. which form cavities after a certain period of usage and thus needed to be replaced. In yet other examples, the consumable components 110 may also include accessories and service components, such as, tires, meters and gauges, valves, supply lines, etc. which may degrade after usage over a period of time and thus need replacement for proper functioning of the machine 100.

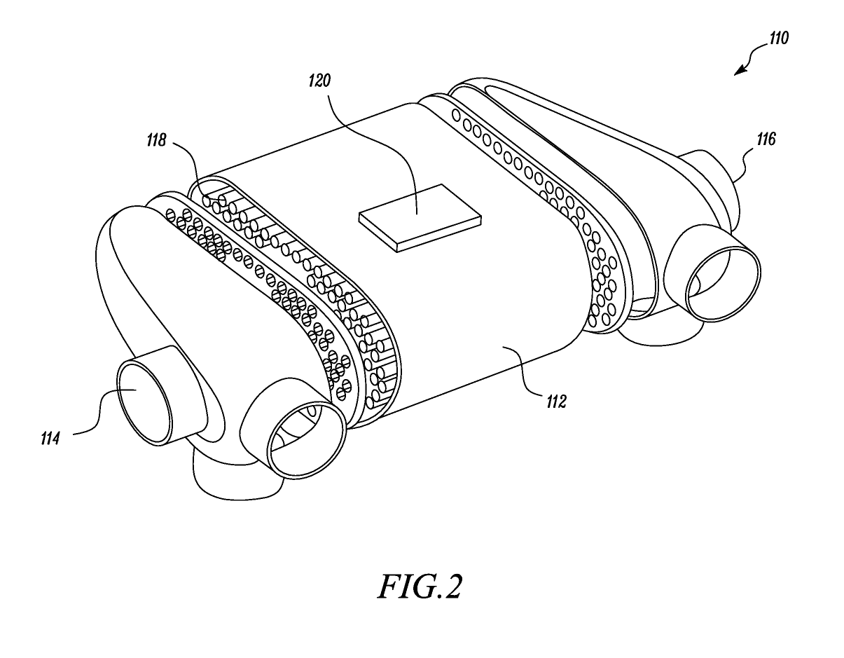

FIG. 2 illustrates an exemplary configuration of the consumable component 110. The consumable component 110 is shown as a filter which is used for treating exhaust gases in the machine 100. The consumable component 110, as shown in FIG. 2, may be designed to remove particulate matter or soot from the exhaust gases. The consumable component 110, as shown in FIG. 2, may include a body 112 in which one or more inlet ports 114 and one or more outlet ports 116 are provided. The consumable component 110 may further include filter elements 118 disposed within the body 112. In the consumable component 110 of FIG. 2, the one or more inlet ports 114 may receive the exhaust gases from a combustion chamber (not shown) of the engine 104 via the inlet ports 114, route the exhaust gases through the filter elements 118 for treatment and subsequently discharge the exhaust gases via the outlet ports 116. In this process, the filter elements 118 may be consumed and/or degraded by accumulation of the particulate matter, etc. Thereafter, the filter elements 118 may no longer be suitable for sufficiently treating the exhaust gases. This may result in the overall emissions control of the machine 100 to be substantially less efficient than expected of a certified system. At this point, it is recommended that the operator may replace the consumable component 110 installed in the machine 100.

According to an embodiment of the present disclosure, the consumable component 110 may be manufactured to include an electronic device 120. The electronic device 120 may be fixed to the body 112 of the consumable component 110, as shown in FIG. 2. The electronic device 120 may be in the form of a tag embedded or attached to the body 112 of the consumable component 110. In one example, the electronic device 120 and its associated circuits may be powered by a battery (not shown) disposed in the consumable component 110 or directly with the electronic device 120. In another example, the electronic device 120 may be powered by an energy harvester unit (not shown), such as, but not limited to, solar cell, piezo cell, and the like. In an alternate example, the electronic device 120 may derive power from the engine 104 of the machine 100.

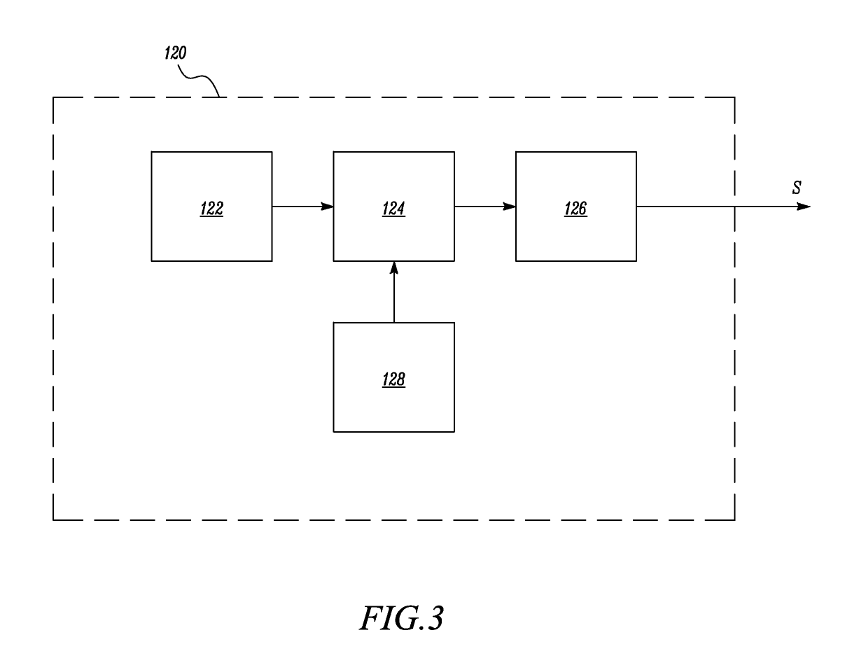

In an exemplary embodiment, as illustrated in FIG. 3, the electronic device 120 may include a memory 122, such as a read-only memory (ROM), random access memory (RAM), non-volatile memory, etc. The memory 122 may be configured to store an identifier code ‘X’ associated with the consumable component 110. It may be understood that the identifier code ‘X’ may be in the form of a data string which may be unique to the corresponding consumable component 110, and therefore be used to distinguish one consumable component from other consumable components of the same or different type.

The electronic device 120 may also include a microcontroller 124 in communication with the memory 122 over a data bus or the like. The microcontroller 124 may be configured to generate a signal ‘S’ indicative of the identifier code ‘X’. The microcontroller 124 may be configured to generate the signal ‘S’ according to one of the wireless communication standards known in the art. In particular, the microcontroller 124 may be configured to encode the information about the identifier code ‘X’ to generate the signal ‘S’. The signal ‘S’ may further be encrypted based on the wireless communication standard adopted for encoding the signal ‘S’.

The electronic device 120 may further include a transmitter 126. The transmitter 126 may be configured to transmit the signal ‘S’ based on the wireless communication standard adopted for encoding the signal ‘S’. In one example, the transmitter 126 may transmit the signal ‘S’ as one of a Bluetooth Low Energy (BLE) signal, a Bluetooth signal, an RFID signal, an infrared signal, a Wi-Fi signal, a NFC signal, a cellular signal, a RuBee signal, a wired signal and a hybrid signal. In an embodiment of the present disclosure, the transmitter 126 may be configured to transmit the signal ‘S’ as a Bluetooth Low Energy (BLE) signal. The microcontroller 124 may be configured to encode the information about the identifier code ‘X’ in the signal ‘S’ as per the Bluetooth Low Energy standard. Hereinafter, the terms “Bluetooth Low Energy signal” and “signal” have been interchangeably used.

The electronic device 120 may also include a timing module 128 in communication with the transmitter 126. The timing module 128 may be one or more algorithms with a set of instructions to regulate the transmitter 126 for transmitting the signal ‘S’. In one example, the timing module 128 may configure the transmitter 126 to transmit the signal ‘S’ continuously after regular intervals of time. In other example, the timing module 128 may configure the transmitter 126 to transmit the signal ‘S’ in response to starting of the machine 100, as may be detected by the ECM of the engine 104. It maybe contemplated by a person skilled in the art that the timing module 128 may regulate the transmission of the signal ‘S’ in order to conserve power consumed by the electronic device 120. In one example, the electronic device 120 may also include an accelerometer (not shown) which may configure the transmitter 126 to transmit the signal ‘S’ in response to a movement of the machine 100.

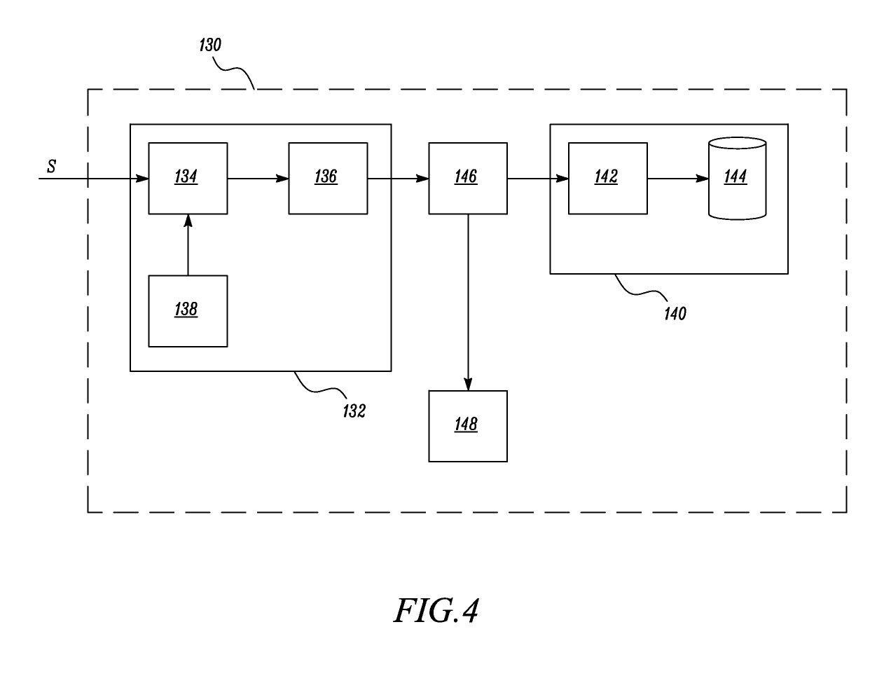

In an embodiment, the present disclosure provides a control system 130, as schematically illustrated in FIG. 4. The control system 130 may be configured to determine a useful life of the consumable component 110. The term “useful life” herein refers to a prescribed period after which a consumable component shall be replaced for efficient working of the machine. In one example, the useful life may be measured in terms of number of hours the consumable component 110 has been used in the machine 100. Alternatively, the useful life may be measured in terms of work performed by the machine 100, for example, the number of miles the machine 100 has travelled or the like. Generally, each consumable component 110 has a useful life thereof. The useful life of the consumable components 110 may be pre-determined based on running tests on one of a similar type of consumable component. It may be contemplated that the consumable components of same model, for example, oil filters designed for a specific machine, may have an equivalent useful life.

The control system 130 may include a transceiver 132. The transceiver 132 may be disposed in the machine 100, for example, in the operator cabin 106. The transceiver 132 may be disposed in wireless communication with the transmitter 126 of the electronic device 120. The transceiver 132 may be configured to monitor for the signal ‘S’ transmitted from the consumable component 110 installed in the machine 100. The transceiver 132 may also be configured to receive the signal ‘S’ therein.

The transceiver 132 may include a microcontroller 134 configured to determine the identifier code ‘X’ from the signal ‘S’, in response to receiving the signal ‘S’. The microcontroller 134 may be configured to decode the signal ‘S’ to determine the identifier code ‘X’. It may be contemplated that the microcontroller 134 may process the signal ‘S’ with the same wireless communication standard as used by the microcontroller 124 of the electronic device 120, in order to decode/decrypt the signal ‘S’. In an embodiment of the present disclosure, the microcontroller 134 may be configured to use the Bluetooth Low Energy standard for decoding the signal ‘S’.

The transceiver 132 may also include a memory 136 in communication with the microcontroller 134, such as a random access memory (RAM), a non-volatile memory, etc. The memory 136 may be configured to receive and store the identifier code ‘X’, as decoded by the microcontroller 134. The transceiver 132 may also include a timing module 138. The timing module 138 may be one or more algorithms with a set of instructions to regulate the transceiver 132 for monitoring the signal ‘S’. In one example, the timing module 138 may configure the transceiver 132 to monitor for the signal ‘S’ after regular intervals of time. In other example, the timing module 138 may configure the transceiver 132 to monitor for the signal ‘S’ in response to starting of the machine 100, as detected by the ECM of the engine 104. It may be contemplated that the timing module 138 may regulate the monitoring of the signal ‘S’ in order to conserve power in the transceiver 132.

The control system 130 may also include a database 140. The database 140 may include a server 142 and a memory unit 144. The server 142 may include one or more of processors, microprocessors, microcontrollers, and other processing means for carrying out instructions based on some algorithms. The server 142 may be configured to store, organize, sort, filter, and/or arrange data in the memory unit 144. The memory unit 144 may include one or more mass media storage devices, such as, but not limited to, hard drives, magnetic tapes, CD-ROMs, DVD-ROMs, and the like. The memory unit 144 may be configured to store data including a set of pre-stored identifier codes. The set of pre-stored identifier codes may include a number of pre-stored identifier codes. The pre-stored identifier codes corresponds to the identifier codes ‘X’ for each of the consumable component 110 manufactured with the electronic device 120 of the present disclosure. The memory unit 144 may also include record about the useful life of the consumable component 110 corresponding to each of the pre-stored identifier code.

The control system 130 may further include a controller 146. The controller 146 may be a logic unit using any one or a combination of a processor, a microprocessor, a microcontroller, or any other suitable means to execute one or more algorithms predefined therein. The controller 146 may be disposed in communication with the transceiver 132 and the database 140. In one example, the controller 146 may form a part of the transceiver 132 in the control system 130. Further the functions of the controller 146 may be integrated into the microcontroller 134.

The controller 146 may be configured to match the identifier code ‘X’ received from the transceiver 132 with the set of pre-stored identifier codes in the database 140. Specifically, the controller 146 may send instructions to the server 142 to compare the data string of the identifier code ‘X’ with data strings of the pre-stored identifier codes. The server 142 may check for the pre-stored identifier code with a data string equivalent to the data string of the identifier code ‘X’. The server 142 may, then, send a confirmation to the controller 146 that a match for the identifier code ‘X’ has been found in the memory unit 144. This process of searching a database is well known the art and has not been described in more detail for the brevity of the disclosure.

According to an embodiment of the present disclosure, in case the identifier code ‘X’ matches with one of the pre-stored identifier codes from the set of pre-stored identifier codes, the controller 146 may be configured to receive record about the useful life of the consumable component 110 corresponding to the pre-stored identifier code found to match the identifier code ‘X’. The controller 146 may be further configured to generate a first value ‘V1’, indicative of the useful life of the consumable component 110. The first value ‘V1’ may be generated based on the received record about the useful life. In an alternative embodiment, the controller 146 may be configured to generate the first value ‘V1’ based on some information about the consumable component 110 already stored therein, and therefore may not require to receive record about the useful life from the database 140.

In an embodiment, if the identifier code ‘X’ does not match with any of the pre-stored identifier codes from the set of pre-stored identifier codes, the controller 146 may be configured to generate a second value ‘V2’ indicative of the useful life of the consumable component 110. In an embodiment, the controller 146 may be further configured to generate the second value ‘V2’ in response to not receiving the signal ‘S’ at the first place, that is, for the consumable component 110 which may be manufactured without the electronic device 120 associated therewith.

In an embodiment, the second value ‘V2’ may be lesser than the first value ‘V1’. In other words, the first value ‘V1’ may be greater than the second value ‘V2’. The first value ‘V1’ may be greater than the second value ‘V2’ by a margin ‘A’. The margin ‘A’ may be defined in terms of an absolute number, a percentage or a ratio of the first value ‘V1’ and the second value ‘V2’. In an embodiment, the margin ‘A’ may represent a margin of error for the second value ‘V2’ with respect to the first value ‘V1’ as described in further detail below. In an example, for a consumable component for which the first value ‘V1’ is generated and set as 1000 units, then for a similar type of consumable component for which the second value ‘V2’ is generated, the second value ‘V2’ may be set as 750 units.

The control system 130 may also include one or more output devices 148 configured to communicate the first value ‘V1’ and the second value ‘V2’, as generated by the controller 146, to the operator of the machine 100. The output devices 148 may be configured to receive the first value ‘V1’ and the second value ‘V2’, as generated, directly from the controller 146. The output devices 148 may employ any combination of display screens, touchscreens, light-emitting diodes (LEDs), speakers, and the like, to provide one or more of visual and/or audible indications about the useful life of the consumable component 110 installed in the machine 100.

In one example, the output devices 148 may be disposed in the operator cabin 106 from where the operator may check and monitor the useful life of the consumable components 110 installed in the machine 100, such as for the manually operated machines 100. In other example, the output devices 148 may be in the form of a mobile device, such as a smartphone, a tablet, a PDA, or the like which enables the operator to remotely check and monitor the useful life of the consumable components 110 installed in the machine 100, such as for the automatically operated machines 100.

The controller 146 may be further configured to generate a cautionary indicator ‘C’ in response to generation of the second value ‘V2’. The cautionary indicator ‘C’ may be communicated to the operator using a color-coded scheme. For example, the cautionary indicator ‘C’ may be presented in ‘RED’ to indicate that the machine 100 includes a consumable component with a relatively low useful life. Further, the controller 146 may be configured to generate an approval indicator ‘A’ in response to generation of the first value ‘V1’. The approval indicator ‘A’ may be presented, for example, in ‘GREEN’ to indicate that the machine 100 includes a consumable component with a relatively high useful life. The cautionary indicator ‘C’ and the approval indicator ‘A’ may be communicated to the operator by the one or more output devices 148 or any other alternate means.

In one example, the control system 130 may be implemented in a computing device (not shown) disposed on-board the machine 100, like, in the operator cabin 106. That is, the controller 146 and the database 140 may be located on-board the machine 100. In other example, the database 140 may be disposed in a cloud server (not shown) and the controller 146 may be disposed in the machine 100, having a modem (not shown) to access the database 140. In such case, the controller 146 and the database 140 may be in communication with each other using any suitable network, such as, cellular network, Wi-Fi network, Hybrid network, etc. In some other example, the control system 130 may be implemented in a mobile device (not shown) with the operator, where the operator may be locally/remotely monitoring the machines 100. In yet other example, the control system 130 may partially be implemented in a cloud based server (not shown) and partially in the mobile device. As used herein, the “operator” may include someone who is using a filter (for example, a “customer” or a “user”). The “operator” may further include someone who is monitoring the useful life of a filter to determine when the filter should be replaced (for example, “service personnel”).

### Industrial Applicability

The present disclosure provides a system and method for determining a useful life of a consumable component. As discussed, since using a consumable component beyond a useful life may damage a machine. Therefore it may be crucial to have accurate information about the useful life of consumable components installed in the machine. Also, as discussed, it may be difficult to accurately determine the useful life of third-party or counterfeit products. Generally, the third-party or counterfeit products cannot be expected to last for a period equivalent to the useful life for an original consumable component. This may be irrespective of what information about the useful life has been provided with such products. However, the manufacturer of the machine may not afford the risk to allow for use of such third-party or counterfeit products at least beyond their possible/expected useful life in order to avoid the damage to the machine.

The present disclosure provides a system and method to determine accurate information about the useful life of the consumable components and further overcome the problems associated with using the third-party or counterfeit products in the machine. The present system and method differentiates between the original consumable component and third-party or counterfeit products of the same type, and further provides a margin for the useful life of third-party or counterfeit products as compared to the original consumable component, and thus effectively communicate a reduced useful life for the third party or counterfeit products in comparison to the useful life for the original consumable component of same type. Thereby, the present system and method may reduce the risk of using such third-party or counterfeit products in the machine for a period beyond its possible/expected useful life.

The electronic device 120, such as a Bluetooth Low Energy tag, associated the consumable component 110 provides the identifier code ‘X’ unique to the consumable component 110. The identifier code ‘X’ may be used to distinguish the consumable components 110 and further to determine the useful life of each consumable component 110 installed in the machine 100 relatively easily using the control system 130 of the present disclosure. The control system 130 may particularly be helpful, for example, to track useful life of multiple consumable components 110 installed in a machine and/or in a worksite that involves maintaining a large fleet of different types of machines.

FIG. 4 diagrammatically illustrates a computer implemented method 200 for determining useful life of the consumable component 110 of the machine 100, according to which the controller 146 may be configured to operate. As shown in step 202, the method 200 includes monitoring for the signal ‘S’ indicative of the identifier code ‘X’ associated with the consumable component 110. The signal ‘S’ may be monitored by the transceiver 132 of the control system 130. The timing module 128, in the control system 130, may further regulate the monitoring of the signal ‘S’ by the transceiver 132.

Further in step 204, the method 200 includes determining the identifier code ‘X’ from the signal ‘S’, in response to receiving the signal ‘S’. When the signal ‘S’ is received by the transceiver 132, the microcontroller 134 may decode the signal ‘S’ to determine the identifier code ‘X’ using the predefined wireless communication standard. The microcontroller 134 may also decrypt the signal ‘S’ to determine the identifier code ‘X’. Further the identifier code ‘X’, as determined, may be stored in the memory 136 of the control system 130.

In step 206, the method 200 includes matching the identifier code ‘X’ with the set of pre-stored identifier codes. The controller 146, in the control system 130, may issue instructions to the server 142 to compare the identifier code ‘X’, as determined, with the pre-stored identifier codes in the set of pre-stored identifier codes, as stored in the memory unit 144 of the database 140. The server 142 may check and find the pre-stored identifier code which matches the identifier code ‘X’.

Further in step 208, the method 200 includes generating the first value ‘V1’, indicative of the useful life of the consumable component 110, if the identifier code ‘X’ matches with one of the pre-stored identifier codes from the set of pre-stored identifier codes. Otherwise in step 210, the method 200 includes generating the second value ‘V2’, indicative of the useful life of the consumable component 110, if the identifier code ‘X’ does not match with any of the pre-stored identifier codes from the set of pre-stored identifier codes. The first value ‘V1’ and the second value ‘V2’ may be generated using records corresponding to the pre-stored identifier code matched with the identifier code ‘X’.

Moving on, FIG. 9 illustrates a detailed embodiment of a computer implemented method 300 for determining the useful life of the consumable component 110 of the machine 100. In step 302, the method 300 includes monitoring for the signal ‘S’, indicative of the identifier code ‘X’, associated with the consumable component 110. In step 304, the method 300 includes checking if the signal ‘S’ is received or not. When it is determined that the signal ‘S’ is received, the method 300 includes determining the identifier code ‘X’ from the signal ‘S’, as illustrated in step 306. Otherwise, in step 308, the method 300 includes generating the second value ‘V2’, indicative of the useful life of the consumable component 110.

In step 310, the method 300 includes matching the identifier code ‘X’ with the set of pre-stored identifier codes. If the identifier code ‘X’ matches with any of the pre-stored code in the set of pre-stored identifier codes, the method 300, in step 312, includes generating the first value ‘V1’, indicative of the useful life of the consumable component 110. In case the identifier code ‘X’ does not match with any of the pre-stored code in the set of pre-stored identifier codes, the method 300, in step 314, includes generating the second value ‘V2’, indicative of the useful life of the consumable component 110.

The method 200, 300 also includes communicating the useful life based on the first value ‘V1’ or the second value ‘V2’, as generated, to the operator via the output device 148. It may be understood from the disclosure that as the second value ‘V2’ may be generated in case of the consumable component 110 being a third party or a counterfeit product. Also, since the second value ‘V2’ may be lesser than the first value ‘V1’, the useful life communicated to the operator may be relatively less compared to the useful life that may be communicated in case of the original consumable component 110, as determined by the first value ‘V1’.

While aspects of the present disclosure have been particularly shown and described above, it will be understood by those skilled in the art that various additional aspects may be contemplated by the modification of the disclosed machines, systems and methods without departing from the spirit and scope of what is disclosed. Such aspects should be understood to fall within the scope of the present disclosure as determined based upon the claims and any equivalents thereof.

What is claimed is:

1. A method for determining a useful life of a consumable component of a machine, the method comprising:
monitoring for a signal indicative of an identifier code associated with the consumable component;
determining the identifier code from the signal, in response to receiving the signal;
matching the identifier code with a set of pre-stored identifier codes;
generating a first value, indicative of the useful life of the consumable component, if the identifier code matches with one of the pre-stored identifier codes from the set of pre-stored identifier codes; and
generating a second value, indicative of the useful life of the consumable component, if the identifier code does not match with any of the pre-stored identifier codes from the set of pre-stored identifier codes, the second value being lesser than the first value.

2. The method of claim 1 further comprising, generating the second value in response to not receiving the signal.

3. The method of claim 1 comprising, monitoring for the signal comprising a Bluetooth Low Energy (BLE) signal.

4. The method of claim 1 comprising, monitoring for the signal comprising one of a Bluetooth signal, an RFID signal, an infrared signal, a Wi-Fi signal, a NFC signal, a cellular signal, a RuBee signal and a hybrid signal.

5. The method of claim 2 further comprising, generating a cautionary indicator in response to generation of the second value.

6. The method of claim 2 further comprising, communicating the first value and the second value, as generated, to an operator of the machine.

7. A control system for determining a useful life of a consumable component of a machine, the control system comprising:
a transceiver configured to monitor for a signal indicative of an identifier code associated with the consumable component, the transceiver further configured to determine the identifier code from the signal, in response to receiving the signal;
a database having a set of pre-stored identifier codes; and
a controller in communication with the transceiver and the database, the controller configured to:
match the identifier code with the set of pre-stored identifier codes;
generate a first value, indicative of the useful life of the consumable component, if the identifier code matches with one of the pre-stored identifier codes from the set of pre-stored identifier codes; and
generate a second value, indicative of the useful life of the consumable component, if the identifier code does not match with any of the pre-stored identifier codes from the set of pre-stored identifier codes, the second value being lesser than the first value.

8. The control system of claim 7, wherein the controller is further configured to generate the second value in response to not receiving the signal.

9. The control system of claim 7, wherein the transceiver is configured to monitor for the signal comprising a Bluetooth Low Energy signal.

10. The control system of claim 7, wherein the database is disposed in a cloud server.

11. The control system of claim 8, wherein the controller is further configured to generate a cautionary indicator in response to generation of the second value.

12. The control system of claim 8 further comprising an output device configured to display the first value and the second value, as generated by the controller.

13. A machine having a consumable component installed therein, the machine comprising:
a transceiver configured to monitor for a signal indicative of an identifier code associated with the consumable component, the transceiver further configured to determine the identifier code from the signal, in response to receiving the signal; and
a controller in communication with the transceiver, the controller configured to:
match the identifier code with a set of pre-stored identifier codes;
generate a first value, indicative of the useful life of the consumable component, if the identifier code matches with one of the pre-stored identifier codes from the set of pre-stored identifier codes; and
generate a second value, indicative of the useful life of the consumable component, if the identifier code does not match with any of the pre-stored identifier codes from the set of pre-stored identifier codes, the second value being lesser than the first value.

14. The machine of claim 13, wherein the controller is further configured to generate the second value in response to not receiving the signal.

15. The machine of claim 13, wherein the transceiver is configured to monitor for the signal comprising a Bluetooth Low Energy signal.

16. The machine of claim 13, wherein the transceiver is configured to monitor for the signal after regular intervals of time.

17. The machine of claim 13, wherein the transceiver is configured to monitor for the signal in response to starting of the machine.

18. The machine of claim 14, wherein the controller is further configured to generate a cautionary indicator in response to generation of the second value.

19. The machine of claim 14 further comprising an output device configured to display the first value and the second value, as generated by the controller.

20. The machine of claim 13, wherein the consumable component comprises one or more of an engine oil filter, a transmission oil filter, a coolant filter, an exhaust gas filter, a fuel filter, an engine oil pump, a transmission oil pump, a coolant pump, a fuel pump and any combination thereof.
